(19) United States
(12) Patent Application Publication
(10) Pub. No.: US 2008/0247388 A1
(43) Pub. Date: Oct. 9, 2008

(54) TRANSFERRING A SESSION IN A CLUSTER

(75) Inventor: Gavin Bernard Horn, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/696,083

(22) Filed: Apr. 3, 2007

(51) Int. Cl. H04L 12/56

(52) U.S. Cl. 370/389

(57) ABSTRACT

Various techniques for transferring a session in a cluster are disclosed. In one configuration of a cluster, an apparatus may be configured to communicate with an access terminal. The apparatus may be configured to store a session for the access terminal, the session including a plurality of attributes. The apparatus may be further configured to identify one or more of the attributes required by an access point to serve the access terminal, and provide the one or more attributes to the node.

### BACKGROUND

1. Field

The present disclosure relates generally to telecommunications, and more particularly, to various concepts and techniques for transferring a session in a cluster.

2. Background

A wide area network (WAN) is a communications network that covers a large geographic region. Typically, a WAN is used to connect a large number of communication devices together. The largest and most well-known example of a WAN is the Internet.

In contrast to the broad regional coverage of a WAN, a local area network (LAN) is commonly used to connect together a number of communication devices in a limited area, such as a home, office, or public building. Typically, any number of LANs may be connected together through a WAN to enable users in one location to communicate with users in other locations.

Recently, there has been a tremendous growth in the deployment of wireless LANs (WLAN). A WLAN enables users on mobile handsets to move around within a limited coverage region and still remain connected to the WLAN. These WLANs have paved the way for more sophisticated mobile handsets, which traditionally had been designed for voice communications. As a result, there is an increasing demand for additional services including e-mail, web-browsing, video broadcasts, and so on. The integration of these services into mobile handsets poses various technological challenges for the wireless industry. These challenges include restricted memory capacity and bandwidth considerations, just to name a few. As the wireless industry prepares to meet these challenges, there exists a need for new technology that reduces processing complexity and the transmission of control information through WLANs.

### SUMMARY

A summary of sample aspects of the disclosure follows. For convenience, one or more aspects of the disclosure may be referred to herein simply as “some aspects.”

One aspect of an apparatus is disclosed. The apparatus includes a session manager configured to communicate with an access terminal, the session manager being further configured to store a session for the access terminal, the session comprising a plurality of attributes. The session manager is further configured to identify one or more of the attributes for use by an access point to serve the access terminal, and provide said one or more of the attributes to the access point.

An aspect of a method for maintaining a session for an access terminal is disclosed. The method includes storing a session for the access terminal, the session comprising a plurality of attributes, identifying one or more of the attributes for use by an access point to serve the access terminal, and providing said one or more of the attributes to the access point.

Another aspect of an apparatus is disclosed. The apparatus is configured to communicate with an access terminal. The apparatus includes means for storing a session for the access terminal, the session comprising a plurality of attributes, means for identifying one or more of the attributes for use by an access point to serve the access terminal, and means for providing said one or more of the attributes to the access point.

One aspect of an access point is disclosed. The access point includes a session manager configured to communicate with an access terminal, the session manager being further configured to store a session for the access terminal, the session comprising a plurality of attributes. The session manager is further configured to identify one or more of the attributes for use by another access point to serve the access terminal, and provide said one or more of the attributes to said another access point. The access point further includes a transceiver configured to support a wireless interface with said another access point.

An aspect of a computer program product for enabling a node to communicate with an access terminal is disclosed. The computer program product includes computer-readable medium including code for storing a session for the access terminal, the session comprising a plurality of attributes, code for identifying one or more of the attributes for use by a node to serve the access terminal, and code for providing said one or more of the attributes to the node.

It is understood that other aspects of the invention will become readily apparent to those skilled in the art from the following detailed description, wherein it is shown and described only various aspects of the invention by way of illustration. As will be realized, the invention is capable of other and different configurations and its several details are capable of modification in various other respects, all without departing from the scope of the invention. Accordingly, the drawings and detailed description are to be regarded as illustrative in nature and not as restrictive.

### BRIEF DESCRIPTION OF THE DRAWINGS

FIG. 1 is a conceptual diagram illustrating an example of a cluster connected to a WAN;

FIG. 2 is a conceptual diagram illustrating an example of two clusters connected to a WAN;

FIG. 3 is a diagram illustrating an example of a protocol stack for a cluster;

FIG. 4 is a diagram illustrating an example of the signal flow for transferring a session in a cluster;

FIG. 5 is a block diagram illustrating an example of a node that can function as a RAP in a cluster;

FIG. 6 is a flow diagram illustrating an example of a method for maintaining a session for an access terminal; and

FIG. 7 is a functional block diagram illustrating an example of a node than can function as a RAP in a cluster.

### DETAILED DESCRIPTION

The detailed description set forth below in connection with the appended drawings is intended as a description of various aspects of the invention and is not intended to represent the only aspects of the invention. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

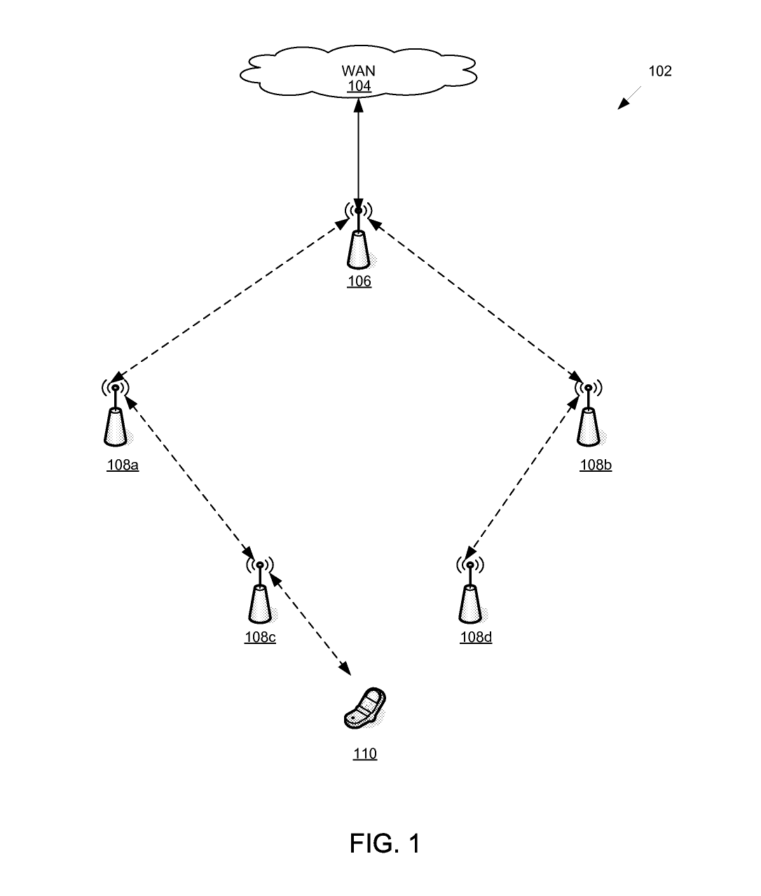

Various concepts presented throughout this disclosure may be utilized across a broad array of networks and communication protocols. One non-limiting example is shown in FIG. 1 where a cluster 102 is connected to a WAN 104. A “cluster” is formed by a number of nodes that join together to provide backhaul services to other nodes in the cluster. In a cluster, data is routed from one node to another until the data reaches its destination. The destination may be a WAN 104 as shown in FIG. 1, or another node in the same or different cluster. A cluster provides a continuous connection through one or more intermediates nodes and is dynamically reconfigurable to maintain a connection if one or more nodes in the cluster fail.

The cluster 102 in FIG. 1 is shown with a node 106 having a wired backhaul connection to the WAN 104. This node 106 will be referred to as a “root access point” (RAP). The cluster 102 is shown with four additional nodes 108a-108d dispersed throughout the geographic coverage region, but may include any number of nodes depending on the geographic reach of the cluster 102. Each of these nodes will be referred a “wireless access point” (WAP) because of its wireless backhaul connection to another node in the cluster 102. Each WAP 108a-108d may be fixed or mobile. Each node in the cluster 102 may be configured, or referred to in the art, as an access point (AP), NodeB, Radio Network Controller (RNC), eNodeB, Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. The various concepts described throughout this disclosure are intended to apply all wireless communication devices regardless of their specific nomenclature.

An access terminal 110 moving through the cluster 102 may access the WAN 104 by establishing a connection with any node in the cluster 102 with sufficient signal strength to support a connection. Once a connection is established, radio link resources may be assigned to the access terminal 110 and various transmission parameters established, such as power control loop values to control the power level of the transmissions by the access terminal 110. The access terminal 110 may be any suitable mobile communications device, including by way of example, a mobile telephone, a personal digital assistant (PDA), a portable television, a personal computer, a laptop computer, a digital camera, a digital camcorder, a game console, a portable audio device, a portable radio, or any other suitable device capable of supporting a radio link with a node in the cluster 102. The access terminal 110 may be referred to by those skilled in the art as a handset, wireless communications device, user terminal, user equipment, mobile station, mobile unit, subscriber unit, subscriber station, mobile radio, radio telephone, wireless station, wireless device, or some other terminology.

The cluster 102 is formed by establishing radio links between the nodes. The radio links may be configured to support both data and control paths between the RAP 106 and the access terminal. In the configuration shown in FIG. 1, a data path is created between the RAP 106 and the access terminal 110 through two intermediate WAPs 108a, 108c. The data path may be dynamically reconfigurable to provide a continuous connection to the WAN 104 for the access terminal 110. By way of example, a new data path can be established between the RAP 106 and the access terminal 110 through intermediate WAPs 108b, 108d due to changing radio conditions, quality of service (QoS) requirements, load balancing, backhaul constraints, or the failure of intermediate WAP 108a or 108c. The ability to reconfigure the data path also enables access terminal mobility. It allows the access terminal to maintain a continuous connection to the WAN 104 as it moves through the cluster 102. In the example illustrated in FIG. 1, a new data path may be established between the RAP 106 and the access terminal 110 through intermediate WAPs 108b, 108d as the access terminal 110 moves from left to right across FIG. 1.

The radio links between the nodes may be supported using any wireless protocol. By way of example, the links may be implemented using Worldwide Interoperability for Microwave Access (WiMAX), infrared protocols such as Infrared Data Association (IrDA), Bluetooth, Ultra-Wide Band (UWB), Wireless Fidelity Alliance (Wi-Fi Alliance), UMTS, LTE, EV-DO, UMB or any other suitable protocol, or any combination thereof. The actual wireless protocol implemented in any particular cluster will depend on the specific application and the overall design constraints imposed on the overall system.

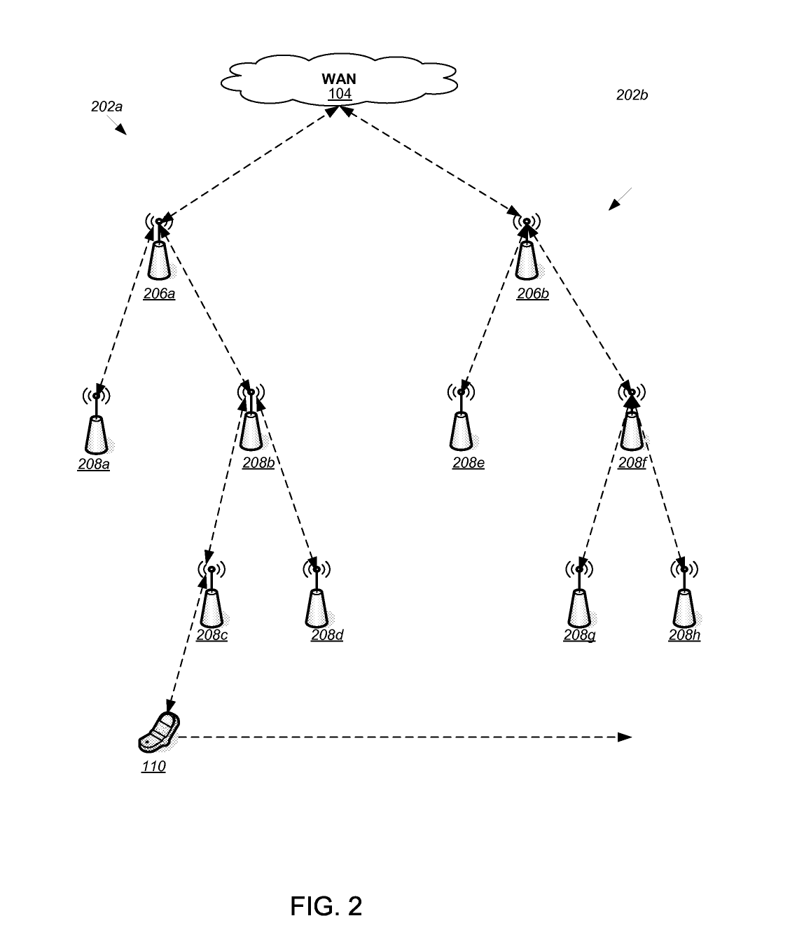

FIG. 2 is a conceptual diagram illustrating an example of two clusters connected to a WAN 104. The first cluster 202a includes a RAP 206a with several WAPs 208a-208d distributed throughout a geographic region. The second cluster 202b also includes a RAP 202b with several WAPs 208e-h distributed throughout a different geographic region. In this example, the RAP 206a in the first cluster 202 is referred to as the “anchor” RAP because it is responsible for routing all packets between the WAN 104 and the access terminal 110. In FIG. 2, the anchor access RAP 206a initially supports a connection with the access terminal 110 through intermediate WAPs 208b, 208c. The intermediate WAP 208c is referred to as the “serving” WAP because it is serving as a connection point for the access terminal 110 to the WAN 104. The anchor RAP 206a is referred to as the “serving” RAP because it is the RAP for the cluster with the serving WAP.

As the access terminal 110 moves from left to right along a series of broken lines in FIG. 2, the access terminal 110 may be handed off from the serving WAP 208c to a target WAP 208d. The WAP 208d is referred to as the “target” WAP because it is the target of the handoff. Once the handoff is complete, the target WAP 608d becomes the serving WAP for the access terminal 110. The data path between the anchor RAP 206a and the access terminal 110 is reconfigured through intermediate WAPs 208b, 208d.

As the access terminal 110 continues to move along the series of broken lines, it will eventually be handed off from the current serving WAP 208d to a new target WAP 208g. However, because the new target WAP 208g is in a different cluster than the serving WAP 208d, the handoff between WAPs may also involve a handoff between the serving RAP 206a and a target RAP 206b. The RAP 206b is referred to as a “target” RAP because it is the RAP for the cluster with the target WAP 208g. The handoff from the serving RAP 206a to the target RAP 206b may be performed at the same time the access terminal 110 is handed off from the serving WAP 208d to the target WAP 208g. Alternatively, the handoff between WAPs 208d, 208g may be performed first with the serving RAP 206a tunneling packets until some time later when the handoff to the target RAPs 206b is performed. Once the handoff is complete, the target WAP 208g becomes the serving WAP and the target RAP 206b becomes the serving RAP. The anchor RAP 206a tunnels packets between the WAN 104 and the serving RAP 206b, and the serving RAP 206b supports a data path to the access terminal 110 through intermediate WAPs 208f, 208g.

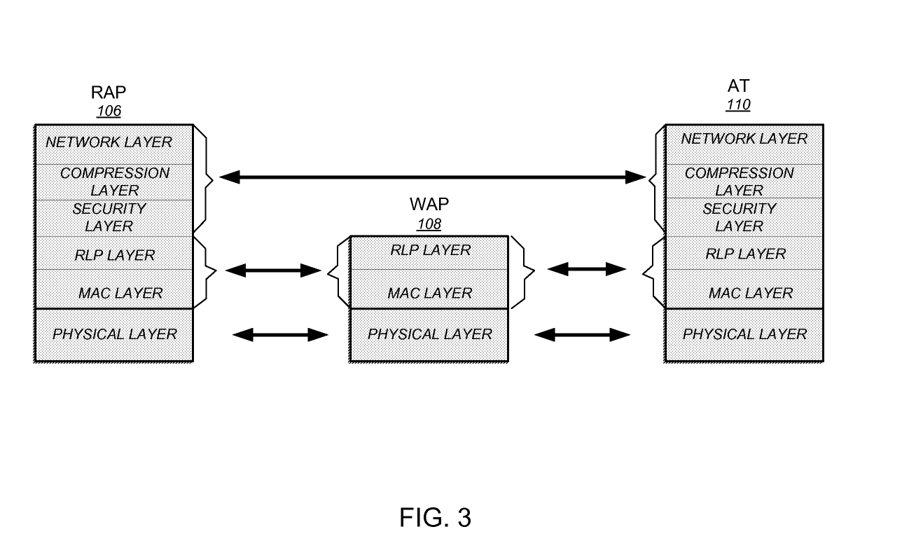

FIG. 3 is a diagram illustrating an example of a protocol stack for a cluster. In this example, an access terminal 110 is shown connected to a RAP 106 through one intermediate WAP 108. The protocol stack includes from top to bottom a network layer, a compression layer, a security layer, a Radio Link Protocol (RLP) layer, a Media Access Control (MAC) layer, and a physical layer.

The network layer is responsible for routing packets between the source and destination. In this example, the network, compression, and security layers are connected between the RAP 106 and the access terminal 110. This configuration allows all network layer functionality to lie outside the WAPs in the cluster. IP header compression for data packets can be performed between the RAP 106 and the access terminal 110, thus conserving valuable bandwidth within the cluster. Security protocols for secured network communications may also be performed between the RAP 106 and the access terminal 110, thus eliminating the need to route encryption keys through the cluster.

The RLP and MAC layers are responsible for routing data between nodes in the cluster. These layers are generally associated with the data link layer in the seven level OSI model. The RLP layer is used to frame packets and ensure reliable delivery of the frames between nodes. The packets may be fragmented and reassembled by the RLP layer on a node-by-node basis. The RLP layer may also support multiple flows between the RAP 106 and the access terminal 110. The MAC layer may be used for addressing and access to the physical layer. The physical layer is responsible for channel structure, frequency, power, modulation, and encoding.

There are three main types of states that exist in the cluster for an access terminal connection to a WAP: a data state, a connection state, and a session state. The “data state” includes things such as header compressor state, RLP flow states and buffers of sent and unsent data, in the cluster on the data path between the access terminal and the anchor RAP during a connection. The data state is very dynamic and difficult to transfer when the data path is reconfigured. The data state may be different at each WAP in the path between the access terminal and the serving RAP

The “connection state” is the state in the cluster on the control path between the access terminal and the serving WAP that is not a preserved when the connection closes. The connection state may include such information as power control loop values, soft handoff timing, air link resource assignments and active set information.

The “session state” is the state in the cluster on the control path between the access terminal and the serving WAP that is preserved when the connection is closed. A master copy of this state is generally stored in a single place for the access terminal, such as the anchor RAP or a central entity in the access network. The session state includes the value of the attributes that are negotiated between the access terminal and the serving WAP. These attributes affect the characteristics of the connection and the service received by the access terminal. For example, the access terminal may negotiate the quality of service (QoS) configuration for a new application and supply new filter and flow specifications to the cluster indicating the QoS service requirements for the application. As another example, the access terminal may negotiate the size and type of the headers used in communication with the serving WAP. The negotiation of a new set of attributes is defined as a session change.

Each intermediate WAP in the control path between the RAP 106 and the access terminal (and not just the serving WAP) may need to know the session state, or some portion of the session state, in order to serve the access terminal. For example, the intermediate WAPs may need the service requirements for different flows for the access terminal in order to properly apply QoS treatment.

The session is relatively static and easy to transfer as the access terminal moves around. However, the entire session is not always used by the access terminal during the course of a connection. For example, in WLANs employing certain radio technology, such as EV-DO and UMB, the access terminal supports a number of different personalities (where a personality consists of a configuration of attributes and protocols), but only one personality is used at a time to communicate with a particular node in the cluster. A personality may be defined to support different capabilities of the nodes or different revisions of a protocol specification. The other personalities are stored and can be used with other nodes in the cluster or at another stage in the connection.

Referring to FIG. 3, if a WAP 108 is supporting data link layer functions, then the attributes associated with higher layers for that personality may not be needed by the WAP 108 to serve the access terminal 110. Furthermore, if certain control, such as address management, is done at the RAP 106, then the WAP 108 does not need to maintain a state for, or necessarily implement, this control either.

In conventional clusters, as an access terminal roams through the cluster and connects to a node, the session is transferred to that node in its entirety. The node then makes use of the attributes as needed to serve the access terminal. If the configuration and management of the session is maintained at the RAP, then only a subset of the attribute values for the personality that is being used to communicate with the access terminal are needed at the intermediate WAPs in the data path. In other words, only the attributes for the actual personality that is being used by the intermediate WAPs in the data path need to be sent by the RAP across the wireless backhaul. This may be achieved by storing the session at the RAP and only sending a subset of that information to the intermediate WAPs to optimize the use of the wireless backhaul. In fact, the cluster can be optimized further to only send those attributes not set to a default value known by the intermediate WAPs.

This concept has potential security advantages as well. For instance, if security is performed on packets before they are sent through the cluster, i.e., there is no security (encryption and authentication) performed by the intermediate WAPs, then the RAP does not need to send security keys over the wireless backhaul.

When the access terminal negotiates attributes with the RAP, or alternatively, the state of the connection changes, the new values for the attributes, or the new state, needs to be distributed to the intermediate WAPs in the data path in a timely manner to ensure optimal service. In some cases, for example if the type of headers changes, the access terminal may not be able to communicate at all with a WAP until these changes are propagated to that WAP. Thus, every intermediate WAP in the data path needs to be updated when the session changes. The RAP, in this instance, only has to send the subset of attributes used by the intermediate WAPs that have changed for the actual personality that is being used by the WAPs and can use the same message types with different content as it did to forward the personality to the WAPs originally.

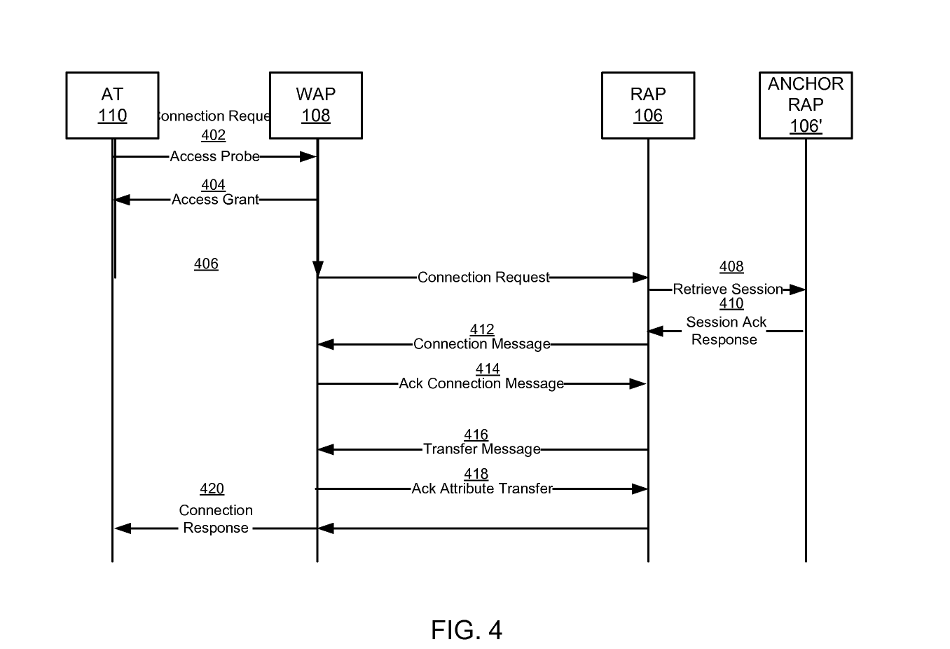

FIG. 4 is a diagram illustrating an example of the signal flow for transferring a session in a cluster. As shown in FIG. 4, the access terminal 110 obtains service from a WAP 108 by sending an access probe 402 on an access channel. Once it receives an access grant 404, the access terminal 110 sends a connection request 406 to the WAP 108. The connection request 406 includes an access payload containing the access terminal's identity and a personality record identifying the configuration it wants to use to communicate with the WAP 108. The WAP 108 forwards the connection request 406 to the RAP 106 via the wireless backhaul and the RAP 106 retrieves a copy of the session from the anchor RAP 106′. The connection request 406 may include the identity of the anchor RAP 106′ or a means of discovering the identity of the anchor RAP 106′. For example, the identity of the anchor RAP 106′ in the connection request 406 may be an IP address to directly address the anchor RAP 106′, or data used to look up the IP address of the anchor RAP 106′. A session retrieval command 408 (including the access terminal's identity as a field) requests a copy of the session from the anchor RAP 106′ and a session acknowledgement response 410 includes the TLV (type, length and value) of all attributes associated with the session.

On a successful access attempt, the access terminal 110 is assigned air interface resources such as a MAC ID and data channels to communicate with that WAP 108 via connection message 412 and acknowledgement 414 between the RAP 106 and the WAP 108. Additionally, once the session is retrieved, the attributes that are needed are transferred from the RAP 106 to the WAP 108 using a transfer message 416 that contains TLVs of attributes needed to serve the access terminal 110. The transfer message is then acknowledged 418 by the WAP 108. A connection response 420 is then sent from the RAP 106 to the access terminal 110 indicating that a connection with the WAP 108 has been opened and the session transferred.

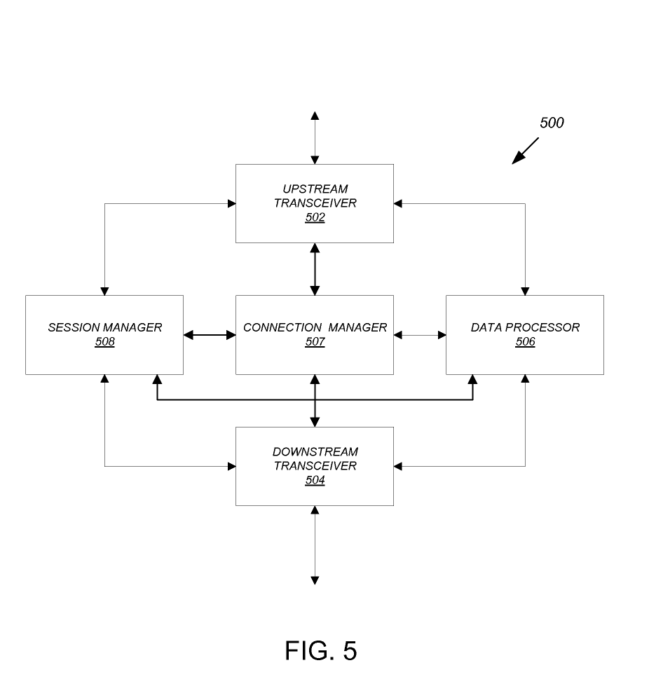

FIG. 5 is a block diagram illustrating an example of an apparatus that can function as a RAP in a cluster. The apparatus 500 is shown with separate upstream and downstream transceivers 502, 504, but the transceivers 502, 504 may be integrated into a singe entity or distributed across multiple entities. The upstream transceiver 502 provides a wired interface to a WAN and the downstream transceiver 504 provides a wireless interface to other nodes in the cluster.

The apparatus 500 also includes a data processor 506. In the downstream direction, the data processor 506 fragments, consolidates, or otherwise arranges packets received from the WAN into frames for routing through the cluster. In the upstream direction, the data processor 506 reassembles the payloads carried in the frames through the cluster into packets for routing over the WAN. The data processor 506 may also perform other functions, such as header compression, security, and other network management functions.

The apparatus 500 also includes a connection manager 507. The connection manager 507 is responsible for maintaining the state of the control path. By way of example, the connection manager 507 may be responsible for power control loop values, soft handoff timing, air link resource assignments and active set information.

The apparatus 500 is also shown with a session manager 508. The session manager 508 is responsible for retrieving the session from the anchor RAP in response to a connection request from the access terminal. The session manager 508 is also responsible for maintaining the configuration and management of the session, including updating the session when the state of the session changes. In one configuration, the session manager 508 identifies each attribute associated with a personality record received from the access terminal with the connection request that is used by the intermediate WAPs to serve the access terminal. These attributes are routed by the session manager 508 to those WAPs. Alternatively, the session manager 508 could route to the intermediate WAPs only the identified attributes that are not set to a default value known by the WAPs.

The apparatus 500 described above may also function as a WAP. In the case of a WAP, the session manager 508 just stores the attributes needed to serve the access terminal and does not actively manage the session or negotiate their values.

The apparatus 500 is shown in FIG. 5 may be implemented within or performed by an integrated circuit (IC), an access point, or other suitable entity. The IC, access point, or other suitable entity may comprise a microprocessor, digital signal processor (DSP), or some other suitable platform capable of executing program code or code segments. A code segment may represent a procedure, a function, a subprogram, a program, a routine, a subroutine, a module, or any combination of instructions, data structures, or program statements. The program code or code segments may reside in computer readable media. The computer readable media may reside on the IC, or alternatively, be a separate storage device, including by way of example, RAM memory, flash memory, ROM memory, EPROM memory, EEPROM memory, registers, hard disk, a removable disk, a CD-ROM, or any other form of storage media known in the art. Computer readable media may also include a carrier wave that encodes a data signal.

As an alternative to a software implementation, or in addition to, the IC, access point, or other suitable entity may be implemented with an application specific integrated circuit (ASIC), a controller, microcontroller, a state machine, a field programmable gate array (FPGA) or other programmable logic component, discrete gate or transistor logic, discrete hardware components, or any combination thereof

Those skilled in the art will recognize the interchangeability of hardware, firmware, and software configurations under these circumstances, and how best to implement the described functionality for each particular application.

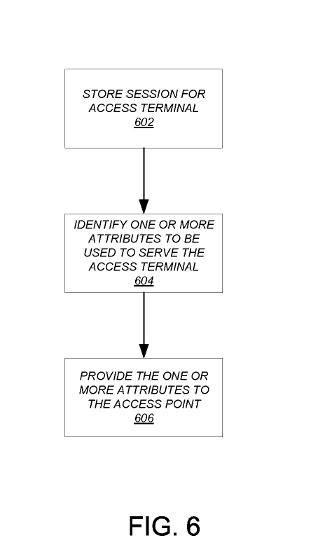

FIG. 6 is a flow diagram illustrating an example of a method for maintaining a session for an access terminal. In step 602, a session for the access terminal is stored. The session includes a plurality of attributes. The session may be retrieved from another access point in response to a connection request from the access terminal.

In step 604, one or more of the attributes for use by an access point to serve the access terminal are identified. The one or more attributes may be identified based on a personality record for the access terminal and/or their value being different from a default value. When the session is updated, the same or different attributes may be identified based on any changes in value from the update.

In step 606, the one or more attributes are provided to the intermediate node. The one or more attributes are provided to the access point in response to a connection request from the access terminal, or in response to a session update.

The one of the one or more attributes provided to the access point may relate to a protocol stack implemented in the access terminal. In this configuration, the one or more attributes provide to the intermediate node may be related to the link layer and the attributes not provided to the intermediate node may be related to one or more layers above the link layer.

Although the operation of the access terminal is described in FIG. 6 as a sequential process, any number of the steps can be performed in parallel or concurrently. In addition, the order of the steps may be re-arranged.

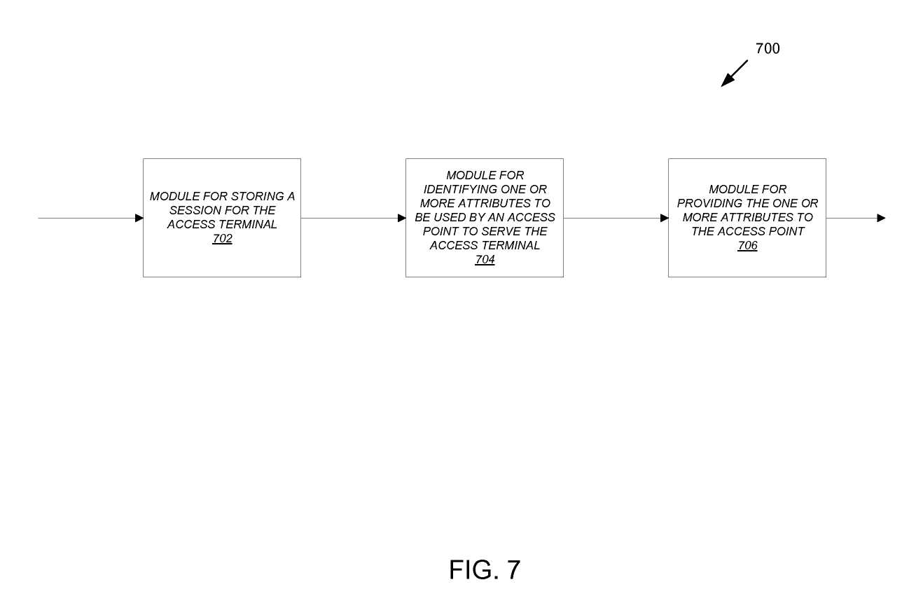

FIG. 7 is a functional block diagram illustrating an example of an access point than can function as a RAP in a cluster. The node 700 includes a module 702 for storing a session for the access terminal. The session includes a plurality of attributes. The node 700 also includes a module 704 for identifying one or more of the attributes for use by another access point to serve the access terminal, and a module 706 for providing said one or more of the attributes to the said another access point.

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, a node may maintain a session for an access terminal by storing a session having a plurality of attributes, identifying one or more attributes for use by the intermediate node to serve the access terminal, and providing the one or more attributes to the intermediate node. The session may or may not be retrieved from another node in response to a connection request from the access terminal prior to being stored at the node. The one or more attributes may be identified based on a personality record for the access terminal, their value being different from a default value, and/or some other criteria. When the session is updated, the same or different attributes may be identified based on any changes in value from the update. The one or more attributes may be provided to the intermediate node in response to a connection request from the access terminal, or in response to a session update, or in response to some other event. The one of the one or more attributes provided to the intermediate node may relate to a protocol stack implemented in the access terminal, or some other functionality of the access terminal. When related to the protocol stack, the one or more attributes provide to the intermediate node may be related to the link layer and the attributes not provided to the intermediate node may be related to one or more layers above the link layer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for wireless communications, comprising:
a session manager configured to store a session for an access terminal, the session comprising a plurality of attributes, the session manager being further configured to identify one or more of the attributes to be used by an access point to serve the access terminal, and provide said one or more of the attributes to the access point.

2. The apparatus of claim 1 wherein the session manager is further configured to provide said one or more of the attributes to the access point in response to a connection request from the access terminal.

3. The apparatus of claim 2 wherein the session manager is further configured to retrieve the session from another access point in response to the request.

4. The apparatus of claim 1 wherein the session manager is further configured to identify said one or more of the attributes to provide to the access point based on a personality record for the access terminal.

5. The apparatus of claim 1 wherein the session manager is further configured to identify said one or more of the attributes to provide to the access point based on their value being different from a default value.

6. The apparatus of claim 1 wherein the session manager is further configured to provide said one or more of the attributes to the access point in response to an update of the session.

7. The apparatus of claim 6 wherein the session manager is further configured to identify said one or more of the attributes based on their value changing from the update.

8. The apparatus of claim 1 wherein at least one of said one or more of the attributes provided to the access point relates to a protocol stack implemented in the access terminal.

9. The apparatus of claim 1 wherein the session manager is further configured not to provide any of the attributes that are not used by the access point to serve the access terminal.

10. The node of claim 9 wherein said one or more of the attributes provided to the node are related to a link layer and the attributes not provided to the access point are related to one or more layers above the link layer.

11. A method for wireless communications, comprising:
storing a session for an access terminal, the session comprising a plurality of attributes;
identifying one or more of the attributes to be used by an access point to serve the access terminal; and
providing said one or more of the attributes to the access point.

12. The method of claim 11 said one or more of the attributes are provided to the access point in response to a connection request from the access terminal.

13. The method of claim 12 further comprising retrieving the session from another access point in response to the request.

14. The method of claim 11 wherein said one or more of the attributes provided to the access point are identified based on a personality record for the access terminal.

15. The method of claim 11 wherein said one or more of the attributes provided to the access point are identified based on their value being different from a default value.

16. The method of claim 11 wherein said one or more of the attributes are provided to the access point in response to an update of the session.

17. The method of claim 16 wherein said one or more of the attributes based on their value changing from the update.

18. The method of claim 11 wherein at least one of said one or more of the attributes provided to the access point relates to a protocol stack implemented in the access terminal.

19. The method of claim 11 further comprising not providing any of the attributes that are not used by the access point to serve the access terminal.

20. The method of claim 19 wherein said one or more of the attributes provided to the access point are related to a link layer and the attributes not provided to the access point are related to one or more layers above the link layer.

21. An apparatus for wireless communications, comprising:
means for storing a session for an access terminal, the session comprising a plurality of attributes;
means for identifying one or more of the attributes to be used by an access point to serve the access terminal; and
means for providing said one or more of the attributes to the access point.

22. The apparatus of claim 21 wherein the means for providing said one or more of the attributes to the access point is configured to provide said one or more of the attributes to the access point in response to a connection request from the access terminal.

23. The apparatus of claim 22 further comprising means for retrieving the session from another access point in response to the request.

24. The apparatus of claim 21 wherein the means for identifying said one or more of the attributes to provide to the access point is configured to identify said one or more of the attributes based on a personality record for the access terminal.

25. The apparatus of claim 21 wherein the means for identifying said one or more of the attributes to provide to the access point is configured to identify said one or more of the attributes based on their value being different from a default value.

26. The apparatus of claim 21 wherein the means for providing said one or more of the attributes to the access point is configured to provide said one or more of the attributes to the access point in response to an update of the session

27. The apparatus of claim 26 wherein the means for identifying said one or more of the attributes to provide to the access point is configured to identify said one or more of the attributes based on their value changing from the update.

28. The apparatus of claim 21 wherein at least one of said one or more of the attributes provided to the access point relates to a protocol stack implemented in the access terminal.

29. The apparatus of claim 21 wherein the means for providing said one or more of the attributes to the access point is configured to not to provide any of the attributes that are not used by the access point to serve the access terminal.

30. The apparatus of claim 29 wherein said one or more of the attributes provided to the access point are related to a link layer and the attributes not provided to the access point are related to one or more layers above the link layer.

31. An access point for wireless communications, comprising:
a session manager configured to store a session for an access terminal, the session comprising a plurality of attributes, the session manager being further configured to identify one or more of the attributes to be used by another access point to serve the access terminal, and provide said one or more of the attributes to said another access point; and
a transceiver configured to support a wireless interface with said another access point.

32. A computer program product for enabling an access point to communicate with an access terminal, comprising:
computer-readable medium comprising codes executable by at least one computer to:
store a session for the access terminal, the session comprising a plurality of attributes;
identify one or more of the attributes to be used by the access point to serve the access terminal; and
provide said one or more of the attributes to the access point.
